(19) United States
(12) Patent Application Publication
(10) Pub. No.: US 2008/0198159 A1
(43) Pub. Date: Aug. 21, 2008

(54) METHOD AND APPARATUS FOR EFFICIENT AND FLEXIBLE SURVEILLANCE VISUALIZATION WITH CONTEXT SENSITIVE PRIVACY PRESERVING AND POWER LENS DATA MINING

(75) Inventors: Lipin LIU, Belle Mead, NJ (US); Kuo Chu Lee, Princeton Junction, NJ (US); Juan Yu, Cranbury, NJ (US); Hasan Timucin Ozdemir, Plainsboro, NJ (US); Norihiro Kondo, Plainsboro, NJ (US)

Correspondence Address: GREGORY A. STOBBS, 5445 CORPORATE DRIVE, SUITE 400, TROY, MI, 48098, US

(73) Assignee: Matsushita Electric Industrial Co., Ltd., Osaka (JP)

(21) Appl. No.: 11/675,942

(22) Filed: Feb. 16, 2007

(51) Int. Cl. G06T 17/10

(52) U.S. Cl. 345/420

(57) ABSTRACT

The surveillance visualization system extracts information from plural cameras to generate a graphical representation of a scene, with stationary entities such as buildings and trees represented by graphical model and with moving entities such as cars and people represented by separate dynamic objects that can be coded to selectively reveal or block the identity of the entity for privacy protection. A power lens tool allows users to specify and retrieve results of data mining operations applied to a metadata store linked with objects in the scene. A distributed model is presented where a grid or matrix is used to define data mining conditions and to present the results in a variety of different formats. The system supports use by multiple persons who can share metadata and data mining queries with one another.

### BACKGROUND OF THE INVENTION

The present disclosure relates generally to surveillance systems and more particularly to multi-camera, multi-sensor surveillance systems. The disclosure develops a system and method that exploits data mining to make it significantly easier for the surveillance operator to understand a situation taking place within a scene.

Surveillance systems and sensor networks used in sophisticated surveillance work these days typically employ many cameras and sensors which collectively generate huge amounts of data, including video data streams from multiple cameras and other forms of sensor data harvested from the surveillance site. It can become quite complicated to understand a current situation given this huge amount of data.

In a conventional surveillance monitoring station, the surveillance operator is seated in front of a collection of video screens, such as illustrated in FIG. 1. Each screen displays a video feed from a different camera. The human operator must attempt to monitor all of the screens, trying to first detect if there is any abnormal behavior warranting further investigation, and second react to the abnormal situation in an effort to understand what is happening from a series of often fragmented views. It is extremely tedious work, for the operator may spend hours staring at screens where nothing happens. Then, in an instant, a situation may develop requiring the operator to immediately react to determine whether the unusual situation is malevolent or benign. Aside from the significant problem of being lulled into boredom when nothing happens for hours on end, even when unusual events do occur, they may go unnoticed simply because the situation produces a visually small image where many important details or data trends are hidden from the operator.

### SUMMARY

The present system and method seek to overcome these surveillance problems by employing sophisticated visualization techniques which allow the operator to see the big picture while being able to quickly explore potential abnormalities using powerful data mining techniques and multimedia visualization aids. The operator can perform explorative analysis without predetermined hypotheses to discovery abnormal surveillance situations. Data mining techniques explore the metadata associated with video data screens and sensor data. These data mining techniques assist the operator by finding potential threats and by discovering “hidden” information from surveillance databases.

In a presently preferred embodiment, the visualization can represent multi-dimensional data easily to provide an immersive visual surveillance environment where the operator can readily comprehend a situation and respond to it quickly and efficiently.

While the visualization system has important uses for private and governmental security applications, the system can be deployed in an application where users of a community may access the system to take advantage of the security and surveillance features the system offers. The system implements different levels of dynamically assigned privacy. Thus users can register with and use the system without encroaching on the privacy of others—unless alert conditions warrant.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a diagram illustrating a conventional (prior art) surveillance system employing multiple video monitors;

FIGS. 2a and 2b are display diagrams showing panoramic views generated by the surveillance visualization system of the invention, FIG. 2b showing the scene rotated in 3D space from that shown in FIG. 2a;

FIG. 3 is a block diagram showing the data flow used to generate the panoramic video display;

FIG. 4 is a plan view of the power lens tool implemented in the surveillance visualization system;

FIG. 5 is a flow diagram illustrating the processes performed on visual and metadata in the surveillance system,

FIGS. 6a, 6b and 6c are illustrations of the power lens performing different visualization functions;

FIG. 7 is an exemplary mining query grid matrix with corresponding mining visualization grids, useful in understanding the distributed embodiment of the surveillance visualization system;

FIG. 8 is a software block diagram illustrating a presently preferred embodiment of the power lens;

FIG. 9 is an exemplary web screen view showing a community safety service site using the data mining and surveillance visualization aspects of the invention;

FIG. 10 is an information process flow diagram, useful in understanding use of the surveillance visualization system in collaborative applications; and

FIG. 11 is a system architecture diagram useful in understanding how a collaborative surveillance visualization system can be implemented.

### DETAILED DESCRIPTION OF THE PREFERRED EMBODIMENTS

The description of the invention is merely exemplary in nature and, thus, variations that do not depart from the gist of the invention are intended to be within the scope of the invention. Such variations are not to be regarded as a departure from the spirit and scope of the invention.

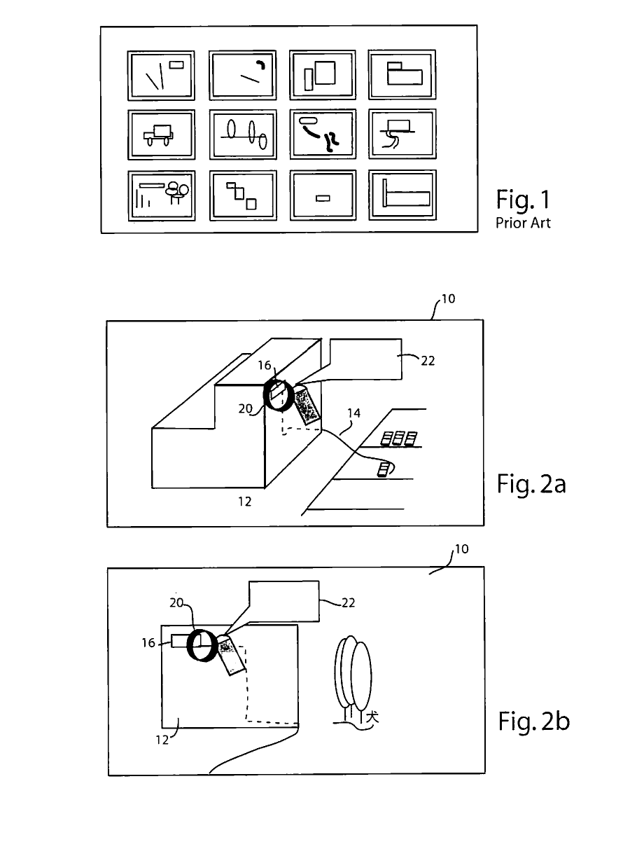

Before a detailed description of the visualization system is presented, an overview will be given. FIG. 1 shows the situation which confronts the surveillance operator who must use a conventional surveillance system. In the conventional system, there are typically a plurality of surveillance cameras, each providing a data feed to a different one of a plurality of monitors. FIG. 1 illustrates a bank of such monitors. Each monitor shows a different video feed. Although the video cameras may be equipped with pan, tilt and zoom (PTZ) capabilities, in typical use these cameras will be set to a fixed viewpoint, unless the operator decides to manipulate the PTZ controls.

In the conventional system, the operator must continually scan the bank of monitors, looking for any movement or activity that might be deemed unusual. When such movement or activity is detected, the operator may use a PTZ control to zoom in on the activity of interest and may also adjust the angle of other monitors in an effort to get additional views of the suspicious activity. The surveillance operator's job is a difficult one. During quiet times, the operator may see nothing of interest on any of the monitors for hours at a time. There is a risk that the operator may become mesmerized with boredom during these times and thus may fail to notice a potentially important event. Conversely, during busy times, it may be virtually impossible for the operator to mentally screen out a flood of normal activity in order to notice a single instance of abnormal activity. Because the images displayed on the plural monitors are not correlated to each other, the operator must mentally piece together what several monitors may be showing about a common event.

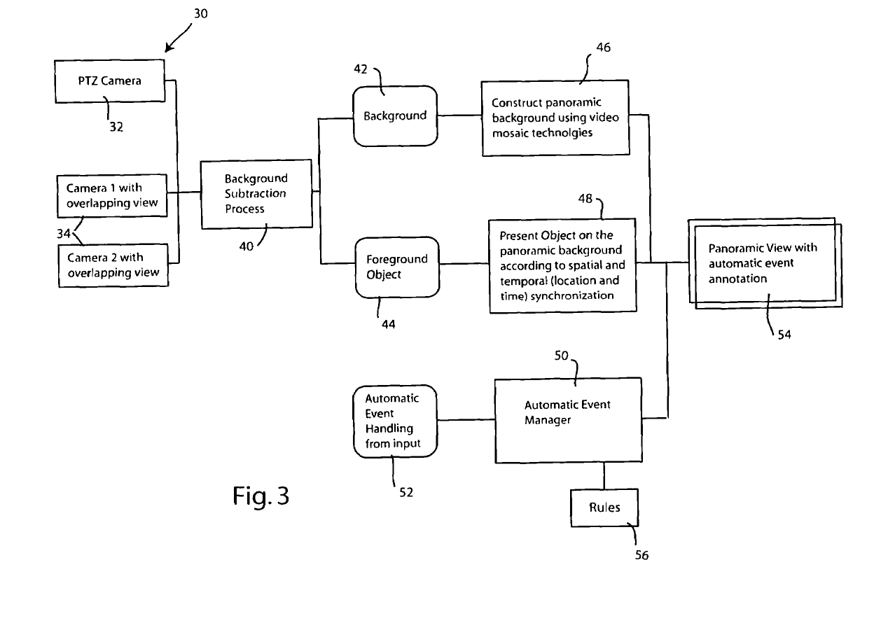

FIGS. 2a and 2b give an example of how the situation is dramatically improved by our surveillance visualization system and methods. Instead of requiring the operator to view multiple, disparate video monitors, the preferred embodiment may be implemented using a single monitor (or a group of side-by-side monitors showing one panoramic view) such as illustrated at 10. As will be more fully explained, video streams and other data are collected and used to generate a composite image comprised of several different layers, which are then mapped onto a computer-generated three-dimensional image which can then be rotated and zoomed into and out of by the operator at will. Permanent stationery objects are modeled in the background layer, while moving objects are modeled in the foreground layer, and where normal trajectories extracted from historical movement data are modeled in one or more intermediate layers. Thus, in FIGS. 2a and 2b, a building 12 is represented by a graphical model of the building placed within the background layer. The movement of an individual (walking from car to 4^{th} floor office) is modeled in the foreground layer as a trajectory line 14. Note the line is shown dashed when it is behind the building or within the building, to illustrate that this portion of the path would not be directly visible in the computer-generated 3D space.

Because modeling techniques are used, the surveillance operator can readily rotate the image in virtual three-dimensional space to get a better view of a situation. In FIG. 2b, the image has been rotated about the vertical axis of the building so that the fourth floor office 16 is shown in plan view in FIG. 2b. Although not depicted in FIGS. 2a or 2b, the operator can readily zoom in or zoom out to and from the scene, allowing the operator to zoom in on the person, if desired, or zoom out to see the entire neighborhood where building 12 is situated.

Because modeling techniques and layered presentation are used, the operator can choose whether to see computer simulated models of a scene, or the actual video images, or a combination of the two. In this regard, the operator might wish to have the building modeled using computer-generated images and yet see the person shown by the video data stream itself. Alternatively, the moving person might be displayed as a computer-generated avatar so that the privacy of the person's identity may be protected. Thus, the layered presentation techniques employed by our surveillance visualization system allow for multimedia presentation, mixing different types of media in the same scene if desired.

The visualization system goes further, however. In addition to displaying visual images representing the selected scene of interest, the visualization system can also display other metadata associated with selected elements within the scene. In a presently preferred embodiment, a power lens 20 may be manipulated on screen by the surveillance operator. The power lens has a viewing port or reticle (e.g., cross-hairs) which the operator places over an area of interest. In this case, the viewing port of the power lens 20 has been placed over the fourth floor office 16. What the operator chooses to see using this power lens is entirely up to the operator. Essentially, the power lens acts as a user-controllable data mining filter. The operator selects parameters upon which to filter, and the uses these parameters as query parameters to display the data mining results to the operator either as a visual overlay within the portal or within a call-out box 22 associated with the power lens.

For example, assume that the camera systems include data mining facilities to generate metadata extracted from the visually observed objects. By way of example, perhaps the system will be configured to provide data indicative of the dominant color of an object being viewed. Thus, a white delivery truck would produce metadata that the object is “white” and the jacket of the pizza delivery person will generate metadata indicating the dominant color of the person is “red” (the color of the person's jacket). If the person wishes to examine objects based upon the dominant color, the power lens is configured to extract that metadata and display it for the object identified within the portal of the power lens.

In a more sophisticated system, face recognition technology might be used. At great distances, the face recognition technology may not be capable of discerning a person's face, but as the person moves closer to a surveillance camera, the data may be sufficient to generate a face recognition result. Once that result is attained, the person's identity may be associated as metadata with the detected person. If the surveillance operator wishes to know the identity of the person, he or she would simply include the face recognition identification information as one of the factors to be filtered by the power lens.

Although color and face recognition have been described here, it will of course be understood that the metadata capable of being exploited by the visualization system can be anything capable of being ascertained by cameras or other sensors, or by lookup from other databases using data from these cameras or sensors. Thus, for example, once the person's identity has been ascertained, the person's license plate number may be looked up using motor vehicle bureau data. Comparing the looked up license plate number with the license plate number of the vehicle from which the user exited (in FIG. 2a), the system could generate further metadata to alert whether the person currently in the scene was actually driving his car and not someone else's. Under certain circumstances, such vehicle driving behavior might be an abnormality that might warrant heightened security measures. Although this is but one example, it should now be appreciated that our visualization system is capable of providing information about potentially malevolent situations that the tradition bank of video monitors simply cannot match. With this overview, a more detailed discussion of the surveillance visualization system will now be presented.

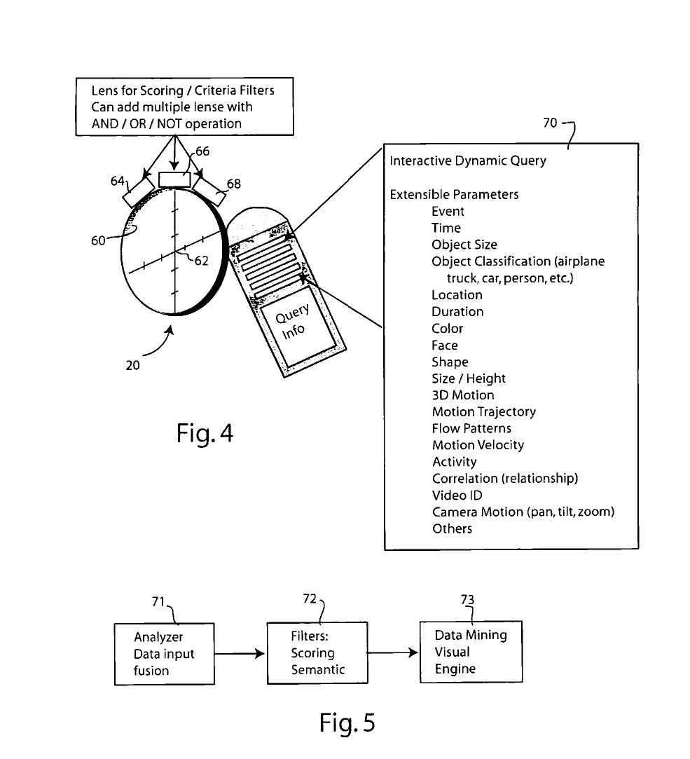

Referring now to FIG. 3, a basic overview of the information flow within the surveillance visualization system will now be presented. For illustration purposes, a plurality of cameras has been illustrated in FIG. 3 at 30. In this case, a pan zoom tilt (PTZ) camera 32 and a pair of cameras 34 with overlapping views are shown for illustration purposes. A sophisticated system might employ dozens or hundreds of cameras and sensors.

The video data feeds from cameras 30 are input to a background subtraction processing module 40 which analyzes the collective video feeds to identify portions of the collective images that do not move over time. These non-moving regions are relegated to the background 42. Moving portions within the images are relegated to a collection of foreground objects 44. Separation of the video data feeds into background and foreground portions represents one generalized embodiment of the surveillance visualization system. If desired, the background and foreground components may be further subdivided based on movement history over time. Thus, for example, a building that remains forever stationery may be assigned to a static background category, whereas furniture within a room (e.g., chairs) may be assigned to a different background category corresponding to normally stationery objects which can be moved from time to time.

The background subtraction process not only separates background from foreground, but it also separately identifies individual foreground objects as separate entities within the foreground object grouping. Thus, the image of a red car arriving in the parking lot at 8:25 a.m. is treated as a separate foreground object from the green car that arrived in the parking at 6:10 a.m. Likewise, the persons exiting from these respective vehicles would each be separately identified.

As shown in FIG. 3, the background information is further processed in Module 46 to construct a panoramic background. The panoramic background may be constructed by a video mosaic technique whereby the background data from each of the respective cameras is stitched together to define a panoramic composite. While the stitched-together panoramic composite can be portrayed in the video domain (i.e., using the camera video data with foreground objects subtracted out), three-dimensional modeling techniques may also be used.

The three-dimensional modeling process develops vector graphic wire frame models based on the underlying video data. One advantage of using such models is that the wire frame model takes considerably less data than the video images. Thus, the background images represented as wire frame models can be manipulated with far less processor loading. In addition, the models can be readily manipulated in three-dimensional space. As was illustrated in FIGS. 2a and 2b, the modeled background image can be rotated in virtual three-dimensional space, to allow the operator to select the vantage point that best suits his or her needs at the time. The three-dimensional modeled representation also readily supports other movements within virtual three-dimensional space, including pan, zoom, tilt, fly-by and fly-through. In the fly-by operation, the operator sees the virtual image as if he or she were flying within the virtual space, with foreground objects appearing larger than background objects. In the fly-through paradigm, the operator is able to pass through walls of a building, thereby allowing the operator to readily see what is happening on one side or the other of a building wall.

Foreground objects receive different processing, depicted at processing module 48. Foreground objects are presented on the panoramic background according to the spatial and temporal information associated with each object. In this way, foreground objects are placed at the location and time that synchronizes with the video data feeds. If desired, the foreground objects may be represented using bit-mapped data extracted from the video images, or using computer-generated images such as avatars to represent the real objects.

In applications where individual privacy must be respected, persons appearing within a scene may be represented at computer-generated avators so that the person's position and movement may be accurately rendered without revealing the person's face or identity. In a surveillance system, where detection of an intruder is an important function, the ability to maintain personal privacy might be counterintuitive. However, there are many security applications where the normal building occupants do not wish to be continually watched by the security guards. The surveillance visualization system described here will accommodate this requirement. Of course, if a thief is detected within the building, the underlying video data captured from one or more cameras 30 may be still be readily accessed to determine the thief's identity.

So far, the system description illustrated in FIG. 3 has centered on how the panoramic scene is generated and displayed. However, another very important aspect of the surveillance visualization system is its use of metadata and the selected display of that metadata to the user upon demand. Metadata can come from a variety of sources, including from the video images themselves or from the models constructed from those video images. In addition, metadata can also be derived from sensors disposed within a network associated with the physical space being observed. For example, many digital cameras used to capture surveillance video can provide a variety of metadata, including its camera parameters (focal length, resolution, f-stop and the like), its positioning metadata (pan, zoom, tilt) as well as other metadata such as the physical position of the camera within the real world (e.g., data supplied when the camera was installed or data derived from GPS information).

In addition to the metadata available from the cameras themselves, the surveillance and sensor network may be linked to other networked data stores and image processing engines. For example, a face recognition processing engine might be deployed on the network and configured to provide services to the cameras or camera systems, whereby facial images are compared to data banks of stored images and used to associate a person's identity with his or her facial image. Once the person's identity is known, other databases can be consulted to acquire additional information about the person.

Similarly, character recognition processing engines may be deployed, for example, to read license plate numbers and then use that information to look up information about the registered owner of the vehicle.

All of this information comprises metadata, which may be associated with the backgrounds and foreground objects displayed within the panoramic scene generated by the surveillance visualization system. As will be discussed more fully below, this additional metadata can be mined to provide the surveillance operator with a great deal of useful information at the click of a button.

In addition to displaying scene information and metadata information in a flexible way, the surveillance visualization system is also capable of reacting to events automatically. As illustrated in FIG. 3, an event handler 50 receives automatic event inputs, potentially from a variety of different sources, and processes those event inputs 52 to effect changes in the panoramic video display 54. The event handler includes a data store of rules 56 against which the incoming events are compared. Based on the type of event and the rule in place, a control message may be sent to the display 54, causing a change in the display that can be designed to attract the surveillance operator's attention. For example, a predefined region within the display, perhaps associated with a monitored object, can be changed in color from green to yellow to red indicate an alert security level. The surveillance operator would then be readily able to tell if the monitored object was under attack simply by observing the change in color.

One of the very useful aspects of the surveillance visualization system is the device which we call the power lens. The power lens is a tool that can provide capability to observe and predict behavior and events within a 3D global space. The power lens allows users to define the observation scope of the lens as applied to one or multiple regions-of-interest. The lens can apply one or multiple criteria filters, selected from a set of analysis, scoring and query filters for observation and prediction. The power lens provides a dynamic, interactive analysis, observation and control interface. It allows users to construct, place and observe behavior detection scenarios automatically. The power lens can dynamically configure the activation and linkage between analysis nodes using a predictive model.

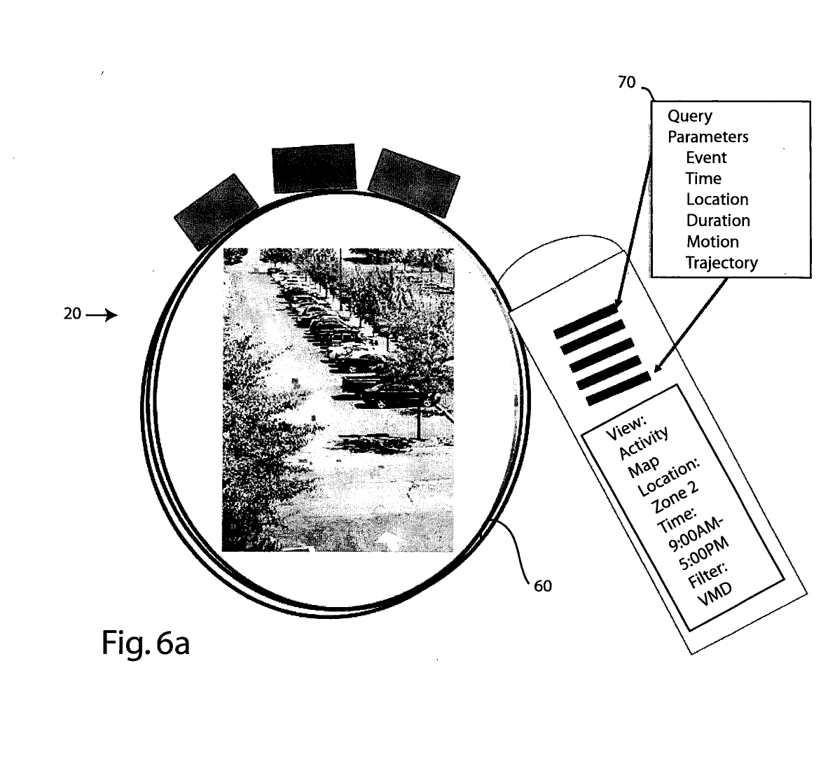

In a presently preferred form, the power lens comprises a graphical viewing tool that may be take the form and appearance of a modified magnifying glass as illustrated at 20 in FIG. 4. It should be appreciated, of course, that the visual configuration of the power lens can be varied without detracting from the physical utility thereof. Thus, the power lens 20 illustrated in FIG. 4 is but one example of a suitable viewing tool. The power lens preferably has a region defining a portal 60 that the user can place over an area of interest within the panoramic view on the display screen. If desired, a crosshair or reticle 62 may be included for precise identification of objects within the view.

Associated with the power lens is a query generation system that allows metadata associated with objects within the image to be filtered and the output used for data mining. In the preferred embodiment, the power lens 20 can support multiple different scoring and filter criteria functions, and these may be combined by using Boolean operators such as AND/OR and NOT. The system operator can construct his or her own queries by selecting parameters from a parameter list in an interactive dynamic query building process performed by manipulating the power lens.

In FIG. 4 the power lens is illustrated with three separate data mining functions, represented by data mining filter blocks 64, 66 and 68. Although three blocks have been illustrated here, the power lens is designed to allow a greater or lesser number of blocks, depending on the user's selection. The user can select one of the blocks by suitable graphical display manipulation (e.g., clicking with mouse) and this causes an extensible list of parameters to be displayed as at 70. The user can select which parameters are of interest (e.g., by mouse click) and the selected parameters are then added to the block. The user can then set criteria for each of the selected parameters and the power lens lens will thereafter monitor the metadata and extract results that match the selected criteria.

The power lens allows the user to select a query template from existing power lens query and visualization template models. These models may contain (1) applied query application domains, (2) sets of criteria parameter fields, (3) real-time mining score model and suggested threshold values, and (4) visualization models. These models can then be extended and customized to meet the needs of an application by utilizing a power lens description language preferable in XML format. In use, the user can click or drag and drop a power lens into the panoramic video display and then use the power lens as an interface for defining queries to be applied to a region of interest and for subsequent visual display of the query results.

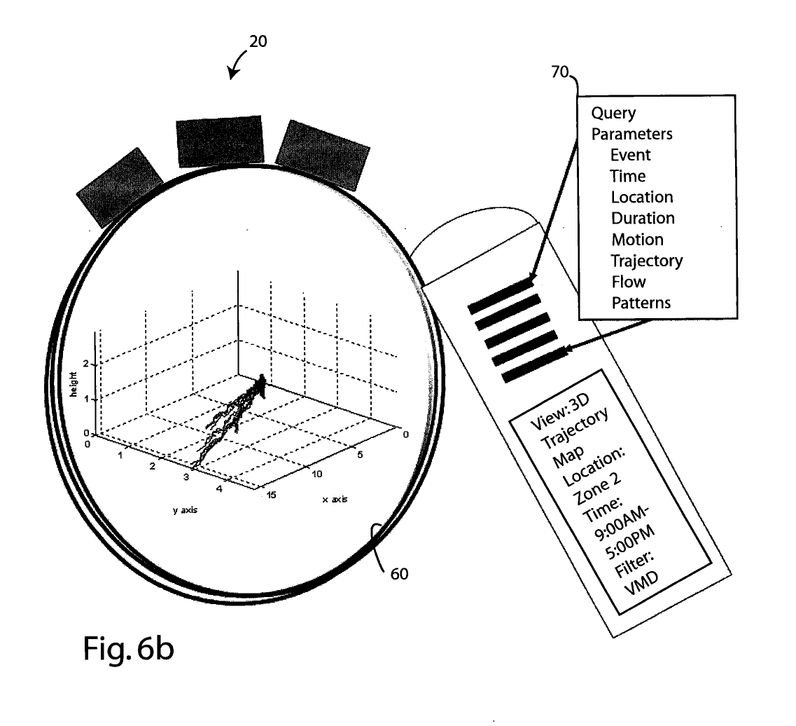

The power lens can be applied and used between video analyzers and monitor stations. Thus, the power lens can continuously query a video analyzer's output or the output from a real-time event manager and then filter and search this input data based on predefined mining scoring or semantic relationships. FIG. 5 illustrates the basic data flow of the power lens. The video analyzer supplies data as input to the power lens as at 71. If desired, data fusion techniques can be used to combine data inputs from several different sources. Then at 72 the power lens filters are applied. Filters can assign weights or scores to the retrieved results, based on predefined algorithms established by the user or by a predefined power lens template. Semantic relationships can also be invoked at this stage. Thus, query results obtained can be semantically tied to other results that have similar meaning. For example, a semantic relationship may be defined between the recognized face identification and the person's driver license number. Where a semantic relationship is established, a query on a person's license number would produce a hit when a recognized face matching the license number is identified.

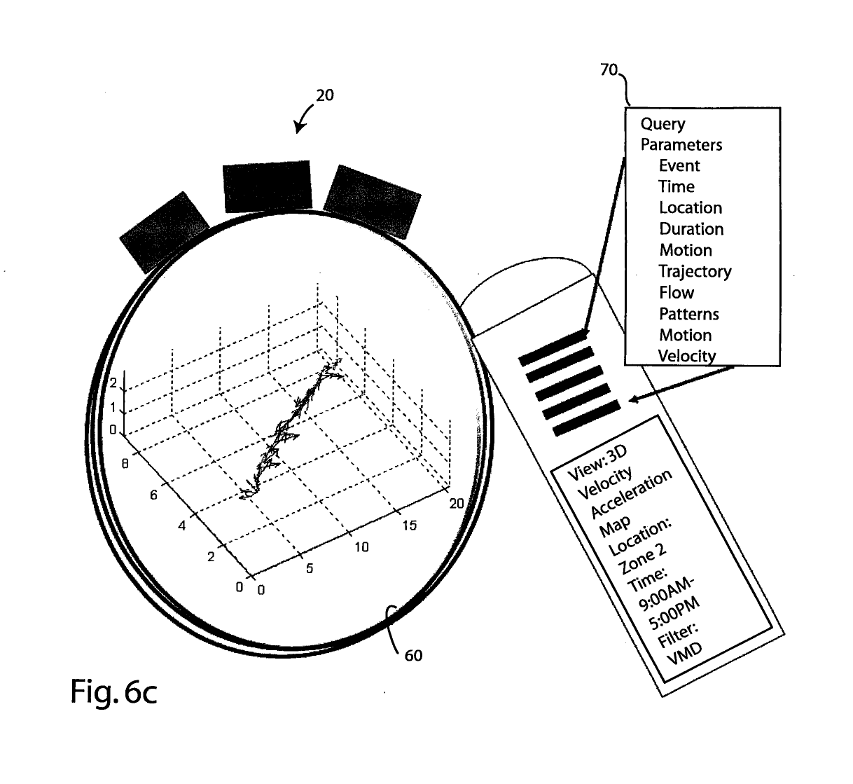

As depicted at 73, the data mining results are sent to a visual display engine so that the results can be displayed graphically, if desired. In one case, it may be most suitable to displayed retrieved results in textual or tabular form. This is often most useful where the specific result is meaningful, such as the name of a recognized person. However, the visualization engine depicted at 74 is capable of producing other types of visual displays, including a variety of different graphical displays. Examples of such graphical displays include tree maps, 2D/3D scatter plots, parallel coordinates plots, landscape maps, density maps, waterfall diagrams, time wheel diagrams, map-based displays, 3D multi-comb displays, city tomography maps, information tubes and the like. In this regard, it should be appreciated that the form of display is essentially limitless. Whatever best suits the type of query being performed may be selected. Moreover, in addition to these more sophisticated graphical outputs, the visualization engine can also be used to simply provide a color or other attribute to a computer-generated avator or other icon used to represent an object within the panoramic view. Thus, in an office building surveillance system, all building occupants possessing RF ID badges might be portrayed in one color and all other persons portrayed in a different color. FIGS. 6a-6c depicts the power lens 20 performing different visualization examples. The example of FIG. 6aillustrates the scene through portal 60 where the view is an activity map of a specified location (parking lot) over a specified time window (9:00 a.m.-5:00 p.m.) with an exemplary VMD filter applied. The query parameters are shown in the parameter call-out box 70.

FIG. 6b illustrates a different view, namely, a 3D trajectory map. FIG. 6c illustrates yet another example where the view is 3D velocity/acceleration map. It will be appreciated that the power lens can be used to display essentially any type of map, graph, display or visual rendering, particularly parameterized ones based on metadata mined from the system's data store.

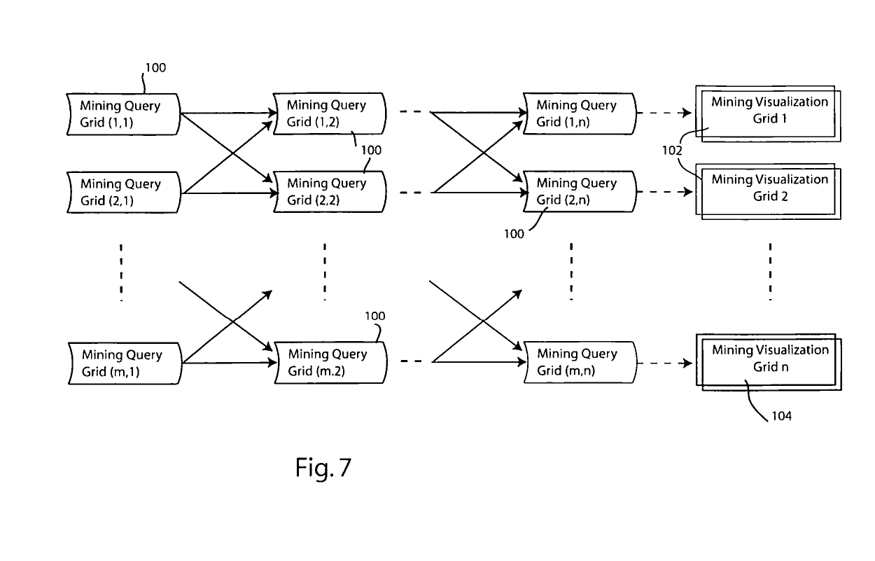

For wide area surveillance monitoring or investigations, information from several regions may need to be monitored and assimilated. The surveillance visualization system permits multiple power lenses to be defined and then the results of those power lenses may be merged or fused to provide aggregate visualization information. In a presently preferred embodiment, grid nodes are employed to map relationships among different data sources, and from different power lenses. FIG. 7 illustrates an exemplary data mining grid based on relationships among grid nodes.

Referring to FIG. 7, each query grid node 100 contains a cache of the most recent query statements and the results obtained. These are generated based on the configuration settings made using the power lenses. Each visualization grid node also contains a cache of the most recent visual rendering requests and rendering results based on the configured setting.

A user's query is decomposed into multiple layers of a query or mining process. In FIG. 7, a two-dimensional grid having the coordinates (m,n) has been illustrated. It will be understood that the grid can be more than two dimensions, if desired. As shown in FIG. 7, each row of the mining grid generates a mining visualization grid, shown at 102. The mining visualization grids 102 are, in turn, fused at 104 to produce the aggregate mining visualization grid 104. As illustrated, note that the individual grids share information not only with their immediate row neighbor, but also with diagonal neighbors.

As FIG. 7 shows, the information meshes, created by possible connection paths between mining query grid entities, allow the results of one grid to become inputs of both criteria and target data set of another grid. Any result from a mining query grid can be instructed to present information in the mining visualization grid. In FIG. 7, the mining visualization grids are shown along the right-hand side of the matrix. Yet, it should be understood that these visualization grids can receive data from any of the mining query grids, according to the display instructions associated with the mining query grids.

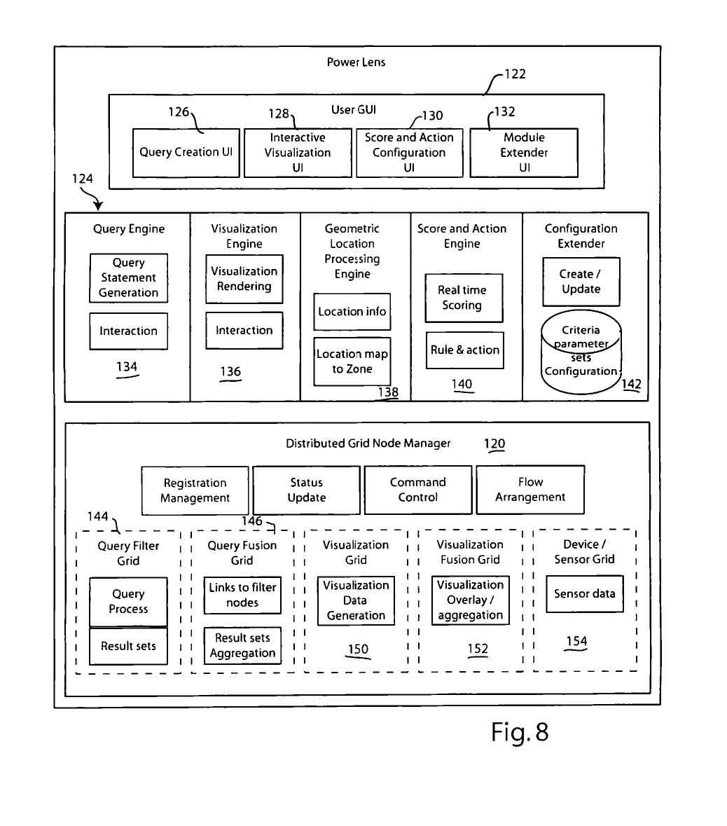

FIG. 8 illustrates the architecture that supports the power lens and its query generation and visualization capabilities. The illustrated architecture in FIG. 8 includes a distributed grid manager 120 that is primarily responsible for establishing and maintaining the mining query grid as illustrated in FIG. 7, for example. The power lens surveillance architecture may be configured in a layered arrangement that separates the user graphical user interface (GUI) 122 from the information processing engines 124 and from the distributed grid node manager 120. Thus, the user graphical user interface layer 122 comprises the entities that create user interface components, including a query creation component 126, and interactive visualization component 128, and a scoring and action configuration component 130. In addition, to allow the user interface to be extended, a module extender component may also be included. These user interface components may be generated through any suitable technology to place graphical components of the display screen for user manipulation and interaction. These components can be deployed either on the server side or on the client side. In one presently preferred embodiment, AJAX technology may be used to embed these components within the page description instructions, so that the components will operate on the client side in an asynchronous fashion.

The processing engines 124 include a query engine 134 that supports query statement generation and user interaction. When the user wishes to define a new query, for example, the user would communicate through the query creation user interface 126, which would in turn invoke the query engine 134.

The processing engines of the power lens also include a visualization engine 136. The visualization engine is responsible for handling visualization rendering and is also interactive. The interactive visualization user interface 128 communicates with the visualization engine to allow the user to interact with the visualized image.

The processing engines 124 also include a geometric location processing engine 138. This engine is responsible for ascertaining and manipulating the time and space attributes associated with data to be displayed in the panoramic video display and in other types of information displays. The geometric location processing engine acquires and scores location information for each object to be placed within the scene, and it also obtains and stores information to map pre-defined locations to pre-defined zones within a display. A zone might be defined to comprise a pre-determined region within the display in which certain data mining operations are relevant. For example, if the user wishes to monitor a particular entry way, the entry way might be defined as a zone and then a set of queries would be associated with that zone.

Some of the data mining components of the flexible surveillance visualization system can involve assigning scores to certain events. A set of rules is then used to assess whether, based on the assigned scores, a certain action should be taken. In the preferred embodiment illustrated in FIG. 8, a scoring and action engine 140 associate scores with certain events or groups of events, and then causes certain actions to be taken based on pre-defined rules stored within the engine 140. By associating a data and time stamp with the assigned score, the score and action engine 140 can generate and mediate real time scoring of observed conditions.

Finally, the information processing engines 124 also preferably include a configuration extender module 142 that can be used to create and/or update configuration data and criteria parameter sets. Referring back to FIG. 4, it will be recalled that the preferred power lens can employ a collection of data mining filter blocks (e.g., block 64, 66 and 68) which each employ a set of interactive dynamic query parameters. The configuration extender module 142 may be used when it is desired to establish new types of queries that a user may subsequently invoke for data mining.

In the preferred embodiment illustrated in FIG. 8, the processing engines 124 may be invoked in a multi-threaded fashion, whereby a plurality of individual queries and individual visualization renderings are instantiated and then used (both separately and combined) to produce the desired surveillance visualization display. The distributed grid node manager 120 mediates these operations. For illustration purposes, an exemplary query filter grid is shown at 144 to represent the functionality employed by one or more mining query grids 100 (FIG. 7). Thus, if a 6×6 matrix is employed, there might be 36 query filter grid instantiations corresponding to the depicted box 144. Within each of these, a query process would be launched (based on query statements produced by the query engine 134) and a set of results are stored. Thus, box 144 diagrammatically represents the processing and stored results associated with each of the mining query grids 100 of FIG. 7.

Where the results of one grid are to be used by another grid, a query fusion operation is invoked. The distributed grid node manager 120 thus supports the instantiation of one or more query fusion grids 146 to define links between nodes and to store the aggregation results. Thus, the query fusion grid 146 defines the connecting lines between mining query grids 100 of FIG. 7.

The distributed grid node manager 120 is also responsible for controlling the mining visualization grids 102 and 104 of FIG. 7. Accordingly, the manager 120 includes capabilities to control a plurality of visualization grids 150 and a plurality of visualization fusion grids 152. Both of these are responsible for how the data is displayed to the user. In the preferred embodiment illustrated in FIG. 8, the display of visualization data (e.g., video data and synthesized two-dimensional and three-dimensional graphical data) is handled separately from sensor data received from non-camera devices across a sensor grid. The distributed grid node manager 120 thus includes the capability to mediate device and sensor grid data as illustrated at 154.

In the preferred embodiment depicted in FIG. 8, the distributed grid node manager employs a registration and status update mechanism to launch the various query filter grids, fusion grids, visualization grids, visualization fusion grids and device sensor grids. Thus, the distributed grid node manager 120 includes registration management, status update, command control and flow arrangement capabilities, which have been depicted diagrammatically in FIG. 8.

The system depicted in FIG. 8 may be used to create a shared data repository that we call a 3D global data space. The repository contains data of objects under surveillance and the association of those objects to a 3D virtual monitoring space. As described above, multiple cameras and sensors supply data to define the 3D virtual monitoring space. In addition, users of the system may collaboratively add data to the space. For example, a security guard can provide status of devices or objects under surveillance as well as collaboratively create or update configuration data for a region of interest. The data within the 3D global space may be used for numerous purposes, including operation, tracking, logistics, and visualization.

In a presently preferred embodiment, the 3D global data space includes shared data of:
Sensor device object: equipment and configuration data of camera, encoder, recorder, analyzer.
Surveillance object: location, time, property, runtime status, and visualization data of video foreground objects such as people, car, etc.
Semi-background object: location, time, property, runtime status, semi-background level, and visualization data of objects which stay in the same background for certain periods of time without movement.
Background object: location, property, and visualization data of static background such as land, building, bridge, etc.
Visualization object: visualization data object for requested display tasks such as displaying surveillance object on the proper location with privacy preservation rendering.

Preferably, the 3D global data space may be configured to preserve privacy while allowing multiple users to share one global space of metadata and location data. Multiple users can use data from the global space to display a field of view and to display objects under surveillance within the field of view, but privacy attributes are employed to preserve privacy. Thus user A will be able to explore a given field of view, but may not be able to see certain private details within the field of view.

The presently preferred embodiment employs a privacy preservation manager to implement the privacy preservation functions. The display of objects under surveillance are mediated by a privacy preservation score, associated as part of the metadata with each object. If the privacy preservation function (PPF) score is lower than full access, the video clips of surveillance objects will either be encrypted or will include only metadata, where identity of the object cannot be ascertained.

The privacy preservation function may be calculated based on the following input parameters:
alarmType—type of alarm. Each type has different score based on the severity.
alarmCreator—source of alarm
location—location of object. Location information is used to protect access based on location. Highly confidential material may only be accessed via a location within the location defined in a set of permissible access location.
privacyLevel—degree of privacy of object.
securityLevel—degree of security of object
alert level—Privacy and security levels can be combined with the location and alert level to support emergency access. For example, if under high security alert and urgent situation, it is possible to override some privacy level
serviceObjective—service objective defines the purpose of the surveillance application, following privacy guideline evolving from policies defined and published by Privacy advocate group or corporation and communities. It is important to show the security system are installed with security purposes, this field can show the embodiment of guideline conformance. For instance, a traffic surveillance service camera with FOV covers the public road that people cannot avoid, may need high level privacy protection even though it is public area. A access control service camera within private property, on the other hand, may not need as high privacy depending on user's setting so that visitor biometric information can be identified.

Preferably, the privacy preservation level is context sensitive. The privacy preservation manager can promote or demote the privacy preserving level based on status of context.

For example, users within a community may share the same global space that contains time, location, and event metadata of foreground surveillance objects such as people and car. A security guard with full privileges can select any physical geometric field of view covered by this global space and can view all historical, current, and prediction information. A non-security guard user, such as a home owner within the community, can view people who walk into his driveway with full video view (e.g. with face of person), and he can view only a partial video view in the community park, but he cannot view areas in other people's houses based on privilege and privacy preservation function. If the context is under an alarm event, such as a person breaks into a user's house and triggers an alarm, the user can get full viewing privileges in privacy preservation function for tracking this person's activities, including the ability to continue to view the person should that person run next door and then to public park and public road. The user can have full rendering display on 3D GUI and video under this alarm context.

In order to support access by a community of users, the system uses a registration system. A user wishing to utilize the surveillance visualization features of the system goes through a registration phase that confirms the user's identity and sets up the appropriate privacy attributes, so that the user will not encroach on the privacy of others. The following is a description of the user registration phase which might be utilized when implementing a community safety service whereby members of a community can use the surveillance visualization system to perform personal security functions. For example, a parent might use the system to ensure that his or her child made it home from school safely.
1. User registers to the system to get the community safety service.
2. The system will give the user a Power Lens to define the region, which they want to monitor, selects the threat detection features and notification methods.
3. After the system gets the above information from user, it will create the information associated with this user into a User Table.
   The User table includes the user name, user ID, password, role of monitoring, service information and list of query objects to be executed (ROI Objects).
   The Service Information includes service identification, service name, and service description, service starting date and time, service ending date and time.
   Details of the user's query requirements are obtained and stored. In this example, assume the user has invoked the Power Lens to select region of monitoring and features of service such as monitoring that a child safely returned home from school. The ROI Object is created to store the location of region information defined by user using Power Lens, Monitoring Rules, which are created based on the monitoring features selected by the user and notification methods user prefer to have, Privacy Rules, which are created based on user role and ROI region privacy setting in the configuration database.
   Save the information into the Centralize Management Database.

The architecture defined above supports collaborative use of the visualization system in at least two respects. First, users may collaborate by supplying metadata to the data store of metadata associated with objects in the scene. For example, a private citizen, looking through a wire fence, may notice that the padlock on a warehouse door has been left unlocked. That person may use the power lens to zoom in on the warehouse door and provide an annotation that the lock is not secure. A security officer having access to the same data store would then be able to see the annotation and take appropriate action.

Second, users may collaborate by specifying data mining query parameters (e.g., search criteria and threshold parameters) that can be saved in the data store and then used by other users, either as a stand-alone query or as part of a data mining grid (FIG. 7). This is a very powerful feature as it allows reuse and extension of data mining schemas and specifications.

For example, using the power lens or other specification tool, a first user may configure a query that will detect how long a vehicle has been parked based on its heat signature. This might be accomplished using thermal sensors and mapping the measured temperatures across a color spectrum for easy viewing. The query would receive thermal readings as input and would provide a colorized output so that each vehicle's color indicates how long the vehicle has been sitting (how long its engine has had time to cool).

A second person could use this heat signature query in a power lens to assess parking lot usage throughout the day. This might be easily accomplished by using the vehicle color spectrum values (heat signature measures) as inputs for a search query that differently marks vehicles (e.g., applies different colors) to distinguish cars that park for five to ten minutes from those that are parked all day. The query output might be a statistical report or histogram, showing aggregate parking lot usage figures. Such information might be useful in managing a shopping center parking lot, where customers are permitted to park for brief times, but employees and commuters should not be permitted to take up prime parking spaces for the entire day.

From the foregoing, it should be also appreciated that the surveillance visualization system offers powerful visualization and data mining features that may be invoked by private and government security officers, as well as by individual members of a community. In the private and government security applications, the system of cameras and sensors may be deployed on a private network, preventing members of the public from gaining access. In the community service application, the network is open and members of the community are permitted to have access, subject to logon rules and applicable privacy constraints. To demonstrate the power that the surveillance visualization system offers, an example use of the system will now be described. The example features a community safety service, where the users are members of a participating community.

This example assumes a common scenario. Parents worry if their children have gotten home from school safely. Perhaps the child must walk from a school bus to their home a block away. Along the way there may be many stopping off points that may tempt the child to linger. The parent wants to know that their child went straight home and were not diverted along the way.

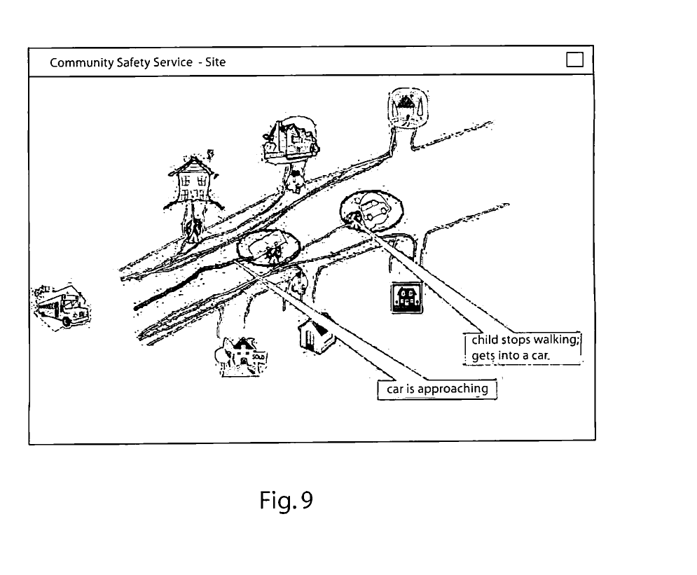

FIG. 9 depicts a community safety service scenario, as viewed by the surveillance visualization system. In this example. it will be assumed that the user is a member of a community who has logged in and is accessing the safety service with a web browser via the Internet. The user invokes a power lens to define the parameters applicable to the surveillance mission here: did my child make it home from school safely? The user would begin by defining the geographic area of interest (shown in FIG. 9). The are includes the bus stop location and the child's home location as well as the common stopping-on-the-way-home locations. The child is also identified to the system, but whatever suitable means are available. These can include face recognition, RF ID tag, color of clothing, and the like. The power lens is then used to track the child as he or she progresses from bus stop to home each day.

As the system learns the child's behavior, a trajectory path representing the “normal” return-home route is learned. This normal trajectory is then available for use to detect when the child does not follow the normal route. The system learns not only the path taken, but also the time pattern. The time pattern can include both absolute time (time of day) and relative time (minutes from when the bus was detected as arriving at the stop). These time patterns are used to model the normal behavior and to detect abnormal behavior.

In the event abnormal behavior is detected, the system may be configured to start capturing and analyzing data surrounding the abnormal detection event. Thus, if a child gets into a car (abnormal behavior) on the way home from school, the system can be configured to capture the image and license plate number of the car and to send an alert to the parent. The system can then also track the motion of the car and detect if it is speeding. Note that it is not necessary to wait until the child gets into a car before triggering an alarm event. If desired, the system can monitor and alert each time a car approaches the child. That way, if the child does enter the car, the system is already set to actively monitor and process the situation.

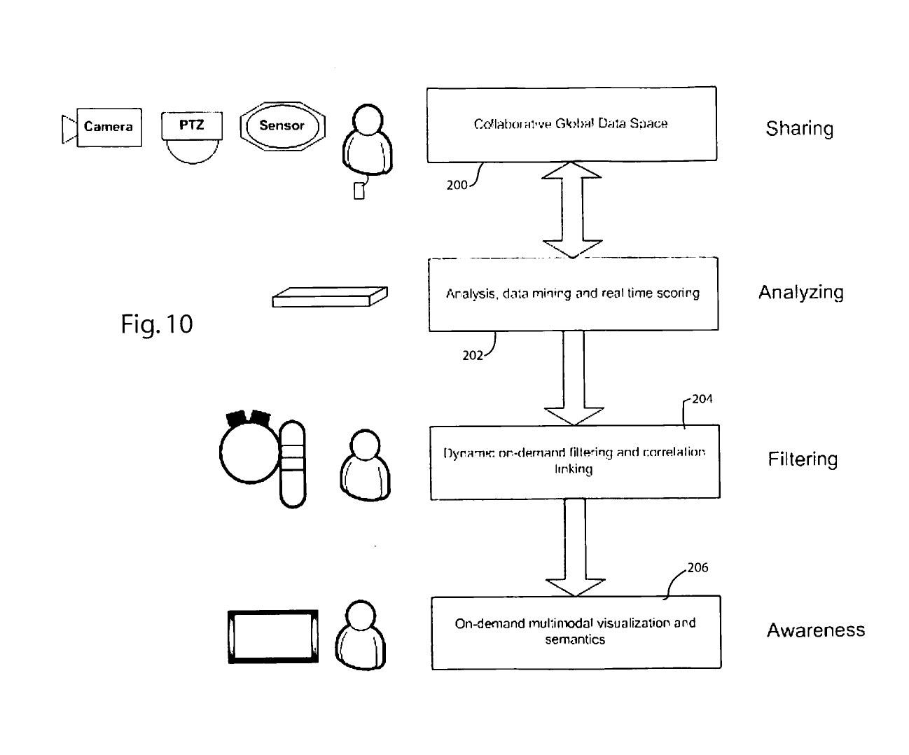

With the foregoing examples of collaborative use in mind, refer now to FIG. 10, which shows the basic information process flow in a collaborative application of the surveillance visualization system. As shown, the information process involves four stages: sharing, analyzing, filtering and awareness. At the first stage, input data may be received from a variety of sources, including stationary cameras, pan-tilt-zoom cameras, other sensors, and from input by human users, or from sensors such as RF ID tags worn by the human user. The input data are stored in the data store to define the collaborative global data space 200.

Based on a set of predefined data mining and scoring processes, the data within the data store is analyzed at 202. The analysis can include preprocessing (e.g., to remove spurious outlying data and noise, supply missing values, correct inconsistent data), data integration and transformation (e.g., removing redundancies, applying weights, data smoothing, aggregating, normalizing and attribute construction), data reduction (e.g., dimensionality reduction, data cube aggregation, data compression) and the like.

The analyzed data is then available for data mining as depicted at 204. The data mining may be performed by any authorized collaborative user, who manipulates the power lens to perform dynamic, on-demand filtering and/or correlation linking.

The results of the user's data mining are returned at 206, where they are displayed as an on-demand, multimodal visualization (shown in the portal of the power lens) with the associated semantics which defined the context of the data mining operation (shown in an associated call-out box associated with the power lens). The visual display is preferably superimposed on the panoramic 3D view through which the user can move in virtual 3D space (fly in, fly through, pan, zoom, rotate). The view gives the user heightened situational awareness of past, current (real-time) and forecast (predictive) scenarios. Because the system is collaborative, many users can share information and data mining parameters; yet individual privacy is preserved because individual displayed objects are subject to privacy attributes and associated privacy rules.

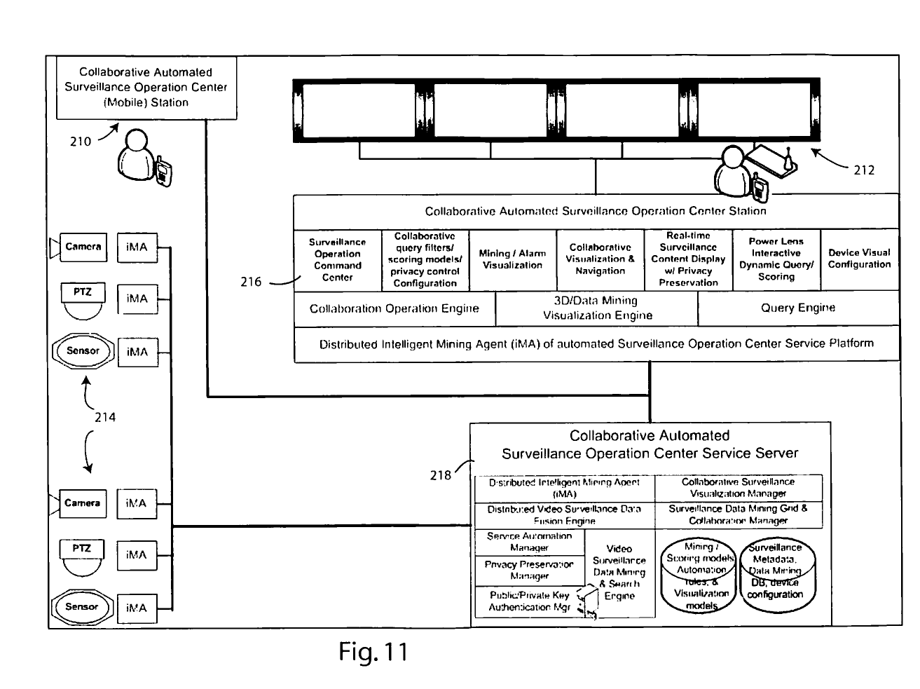

While the collaborative environment can be architected in many ways, one presently preferred architecture is shown in FIG. 11. Referring to FIG. 11, the collaborative system can be accessed by users at mobile station terminals, shown at 210 and at central station terminals, shown at 212. Input data are received from a plurality of sensors 214, which include without limitation: fixed position cameras, pan-tilt-zoom cameras and a variety of other sensors. Each of the sensors can have its own processor and memory (in effect, each is a networked computer) on which is run an intelligent mining agent (iMA). The intelligent mining agent is capable of communicating with other devices, peer-to-peer, and also with a central server and can handle portions of the information processing load locally. The intelligent mining agents allow the associated device to gather and analyze data (e.g., extracted from its video data feed or sensor data) based on parameters optionally supplied by other devices or by a central server. The intelligent mining agent can then generate metadata using the analyzed data, which can be uploaded to or become merged with the other metadata in the system data store.

As illustrated, the central station terminal communicates with a computer system 216 that defines the collaborative automated surveillance operation center. This is a software system, which may run on a computer system, or network of distributed computer systems. The system further includes a server or server system 218 that provides collaborative automated surveillance operation center services. The server communicates with and coordinates data received from the devices 214. The server 218 thus functions to harvest information received from the devices 214 and to supply that information to the mobile stations and the central station(s).

What is claimed is:

1. A method for creating an automated wide area multi-sensor and multi-user surveillance and operation system comprising the steps of:
generating a shared, multi-layer multi-dimensional collaborative data space;
receiving and storing multi-dimensional metadata from at least one surveillance camera and video analyzer to said collaborative data space;
configuring and binding a user defined region of interest with data mining processes, data space, and a multi-layer graphic model representation;
performing data mining processes on said metadata and storing the model results to said collaborative data space,
wherein said configuring and binding step is performed at least in part by contribution by a plurality of users and wherein said data mining processes are performed at least in part based on dynamic specification parameters supplied by a plurality of users.

2. The method of claim 1 wherein said metadata is stored in a collaborative global data space accessible to said plurality of users.

3. The method of claim 1 further comprising performing analysis processing of said metadata selected from the group consisting of analysis, data mining and real time scoring.

4. The method of claim 1 wherein said performing data mining step is performed using dynamic on-demand filtering specified by at least one of said plurality of users.

5. The method of claim 1 wherein said performing data mining step is performed by correlation linking specified by at least one of said plurality of users.

6. The method of claim 1 further comprising generating on-demand a multimodal visualization viewable by at least one of said plurality of users.

7. The method of claim 1 further comprising displaying results of said data mining simultaneously to a plurality of users, where each user has independent control over the nature of the view presented to that user.

8. The method of claim 1 further comprising:
defining a query filter grid comprising a plurality of query processes linked together and using said filter grid to perform said data mining step.

9. The method of claim 1 further comprising:
defining a visualization fusion grid comprising a plurality of visualization components linked together and using said visualization fusion grid to generate a visual display of the results of said data mining step.

10. The method of claim 1 further comprising:
defining a query filter grid comprising a plurality of query processes linked together and using said filter grid to perform said data mining step; and
defining a visualization fusion grid comprising a plurality of visualization components linked together and based on results generated by said query filter grid and using said visualization fusion grid to generate a visual display of the results of said data mining step.

11. A method of presenting surveillance information about a scene containing stationary entities and moving entities, comprising the steps of:
receiving image data of a scene from at least one surveillance camera;
generating a graphic model representing at lease one view of said scene based on said received image data;
configuring said graphic model to have at least one background layer comprising stationary objects representing the stationary entities within said scene, and at least one foreground layer comprising at least one dynamic object representing the moving entities within said scene;
acquiring metadata about said dynamic object and associating said acquired metadata with said dynamic object to define a data store;
using said graphic model to generate a graphical display of said scene by combining information from said background layer and said foreground layer so that the visualized position of said dynamic object relative to said stationary objects is calculated based on knowledge of the physical positions of said stationary entities and said moving entities within said scene;
generating a graphical display of a data mining tool in association with said graphical display of said scene;
using said data mining tool to mine said data store based on predefined criteria and to display the results of said data mining on said graphical display in association with said dynamic object.

12. The method of claim 11 wherein said data mining step is performed by generating a plurality of query processes and using data fusion to generate aggregate results and then displaying said aggregate results using said data mining tool.

13. The method of claim 11 further comprising:
defining a query filter grid comprising a plurality of query processes linked together and using said filter grid to mine said data store.

14. The method of claim 11 further comprising:
defining a visualization fusion grid comprising a plurality of visualization components linked together and using said visualization fusion grid to generate a visual display of the results of said data mining step.

15. The method of claim 11 further comprising:
defining a query filter grid comprising a plurality of query processes linked together and using said filter grid to mine said data store;
defining a visualization fusion grid comprising a plurality of visualization components linked together and based on results generated by said query filter grid and using said visualization fusion grid to generate a visual display of the results of said data mining step.

16. The method of claim 11 further comprising:
receiving user interactive control and selectively performing translation, rotation and combinations of translation and rotation operations upon said graphical model to change the viewpoint of the graphical display.

17. The method of claim 11 further comprising:
using said data mining tool to configure at least one alert condition based on predefined parameters; and
using said data mining tool to mine said data store based on said predefined parameters and to provide a graphical indication on said graphical display when the alert condition has occurred.

18. The method of claim 17 wherein said graphical indication is effected by changing the appearance of at least one stationary object or dynamic object within said scene.

19. The method of claim 11 wherein said data mining tool provides a viewing portal and the method further comprises supplying information in said portal based on the results of said data mining.

20. The method of claim 19 wherein the step of supplying information in said portal comprises displaying information based on data mining results graphically against a coordinate system.

21. The method of claim 19 wherein the step of supplying information in said portal comprises displaying see-through image information by providing a visual rendering of a first object normally obscured in the graphical display by a second object by presenting the second object as invisible.

22. The method of claim 11 wherein said dynamic objects are displayed using computer graphic generated avatars that selectively permit or prohibit display of information disclosing the associated entity's identity.

23. The method of claim 11 further comprising defining a collaborative environment between plural user whereby a first user supplies metadata to said data store, which metadata is then available for use in data mining by a second user.

24. The method of claim 11 further comprising defining a collaborative environment between plural user whereby a first user supplies the configuration of a data mining operation, which configured data mining operation is then available to be invoked in data mining by a second user.

25. A surveillance visualization system comprising:
a camera system providing at least one image data feed corresponding to a view of at least one scene containing stationary entities and moving entities;
a graphics modeling system receptive of said image data feed and operable to construct a computer graphics model of said scene, said model representing said stationary entities as at least one static object and representing said moving entities as dynamic objects separate from said static object;
a data store of metadata associated with said moving entities;
a display generation system that constructs a display of said scene from a user-definable vantage point using said static object and said dynamic objects;
said display generation system having a power lens tool that a user manipulates to select and view the results of data mining query, associated with at least one of the dynamic objects and submitted to said data store for metadata retrieval.

26. The system of claim 25 wherein said camera system includes a plurality of motion picture surveillance cameras covering different portions of said scene.

27. The system of claim 25 wherein said graphics modeling system models said static objects in at least one background layer and models said dynamic objects in at least one foreground layer separate from said background layer and where said dynamic objects are each separately represented from one another.

28. The system of claim 25 wherein said data store also stores metadata associated with stationary entities.

29. The system of claim 25 wherein said data store is deployed on a network accessible by plural users to allow said plural users to each add metadata about a moving entity to said data store.

30. The system of claim 25 wherein said data store also stores data mining query specification information that may be accessed by said power lens tool to produce data mining results.

31. The system of claim 25 wherein said data store is deployed on a network accessible by plural users to allow said plural users to each add data mining query specification information to said data store.

32. The system of claim 25 wherein said display generation system combines said static object and said dynamic objects to define a three-dimensional view of said scene that can be interactively rotated and translated by the user.

33. The system of claim 25 wherein said power lens tool includes user input controls whereby a user specifies at least one alert condition based on predefined parameters and where said power lens provides a graphical indication when said alert condition has occurred.

34. The system of claim 33 wherein said power lens changes the appearance of at least one stationary object or dynamic object when the alert condition has occurred.

35. The system of claim 25 further comprising query filter grid defining a plurality of query processes linked together, said grid being disposed on a network accessible to said power lens tool to facilitate data mining of said data store.

36. The system of claim 25 further comprising visualization fusion grid comprising a plurality of visualization components linked together being disposed on a network accessible to said power lens to generate a visual display of data mining results.

37. The system of claim 25 wherein said power lens includes a portal adapted to display information based on data mining results graphically against a coordinate system.

38. The system of claim 25 wherein said display generator system is adapted to display dynamic objects as computer generated avatars that selectively permit or prohibit display of information disclosing the associated entity's identity.
